(19) United States
(12) Patent Application Publication
(10) Pub. No.: US 2016/0203114 A1
(43) Pub. Date: Jul. 14, 2016

(54) Control of Access and Management of Browser Annotations

(71) Applicant: Microsoft Technology Licensing, LLC, Redmond, WA (US)

(72) Inventors: George S. Karalis, Seattle, WA (US); Melissa S. Kerr, Seattle, WA (US); Megan M. Quintero, Seattle, WA (US); Danielle Lauren Ellbogen, Seattle, WA (US); Kelly Rose McArthur, Seattle, WA (US); Aaron Michael Getz, Bellevue, WA (US); Timothy James Scudder, Bellevue, WA (US); Sean Gary Nordberg, Bellevue, WA (US); Matthew Benjamin Owen, Seattle, WA (US); Ye Tian, Sammamish, WA (US); Shrivastava Hariom Shraddha, Issaquah, WA (US); Wei-Tzu Chen, Redmond, WA (US); Kimberly Eleanor Tee, Redmond, WA (US); Mark Yalovsky, Seattle, WA (US)

(21) Appl. No.: 14/599,875

(22) Filed: Jan. 19, 2015

Related U.S. Application Data
(60) Provisional application No. 62/101,935, filed on Jan. 9, 2015.

(51) Int. Cl. G06F 17/24; G06F 17/21; G06F 17/22; H04L 29/08

(52) U.S. Cl. CPC G06F 17/241; H04L 67/02; G06F 17/212; G06F 17/2235

(57) ABSTRACT

Access and management control of browser annotations are described. In one or more implementations, a method is described to control and manage access to annotations made via a browser to transform a webpage. The method includes displaying the webpage by the browser executed by a computing device; receiving one or more inputs by the computing device via the browser as one or more annotations to the webpage; capturing an image of the displayed webpage and the one or more annotations that are made in relation to the display of the webpage by the browser of the computing device; and controlling access via the browser to the annotated webpage through use of the one or more annotations and the captured image of the webpage.

### RELATED APPLICATIONS

This application claims priority under 35 USC Section 119(e) to U.S. Provisional Patent Application No. 62/101,935, filed Jan. 9, 2015, docket number 356504.01, and titled “Control of Access and Management of Browser Annotations,” the entire disclosure of which is hereby incorporated by reference.

### BACKGROUND

Browsers are one of the primary techniques employed by users to navigate to webpages available via the Internet. The users, for instance, may access webpages related to work (e.g., work related web portals and workflows), their personal life (e.g., a social network), and so forth. As such, users may be exposed to a multitude of webpages in a given day, some of which having content that is desired for subsequent viewing, sharing, and so on. As part of this subsequent access, however, conventional techniques do not support inclusion of annotations within the browser experience, and thus result in a fractured experience involving multiple applications, which is inefficient and could be frustrating to the users.

### SUMMARY

Access and management control of browser annotations is described. In one or more implementations, a method is described to control and manage access to annotations made via a browser to transform a webpage. The method includes displaying the webpage by the browser executed by a computing device; receiving one or more inputs by the computing device via the browser as one or more annotations to the webpage; capturing an image of the displayed webpage and the one or more annotations that are made in relation to the display of the webpage by the browser of the computing device; and controlling access via the browser to the annotated webpage through use of the one or more annotations and the captured image of the webpage.

In one or more implementations, a method is described to control and manage display of annotations made via a browser to transform a webpage. The method includes displaying the webpage by the browser executed by a computing device; receiving one or more inputs by the computing device via the browser as one or more annotations to the webpage; capturing an image of the displayed webpage, the one or more annotations, and hypertext markup language (HTML) associated with the webpage; anchoring the one or more annotations with respective elements of the webpage through use of the captured hypertext markup language (HTML); and controlling display of the annotated webpage to support a plurality of different layouts using the captured hypertext markup language such that the one or more annotations are anchored with the respective elements.

In one or more implementations, a system is described to control and manage access to annotations made via a browser to transform a webpage. The system includes at least one computing device having one or more modules implemented at least partially in hardware. The one or more modules are configured to perform operations including displaying the webpage by the browser executed by a computing device; receiving one or more inputs by the computing device via the browser as one or more annotations to the webpage; capturing an image of the displayed webpage and the one or more annotations that are made in relation to the display of the webpage by the browser of the computing device; identifying a website and a user account associated with the webpage from a uniform resource locator (URL) of the webpage; and providing an option to post the annotated webpage back to the identified user account of the website based on the identifying.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to control access and manage annotations in a browser.

FIG. 2 depicts a system in an example implementation in which an annotation module of a browser of FIG. 1 is shown in greater detail.

FIG. 3 depicts an example implementation showing anchoring of annotations in an annotated webpage.

FIGS. 4-19 depict examples of user interfaces that exhibit user interaction with functionality of the annotation module of FIGS. 1-3 to make, share, save, and access annotations within a context of a browser.

FIG. 20 is a flow diagram depicting a procedure in an example implementation to control and manage access to annotations made via a browser to transform a webpage.

FIG. 21 is another flow diagram depicting a procedure in an example implementation to control and manage access to annotations made via a browser to transform a webpage.

FIG. 22 illustrates an example system including various components of an example device that can be implemented as any type of computing device as described with reference to FIGS. 1-21 to implement embodiments of the techniques described herein.

### DETAILED DESCRIPTION

### Overview

Browsers are utilized as a primary tool to navigate to different webpages on the Internet. When users are on a webpage and want to remember something specific or take notes, however, there is no conventional way to do so within the browser. Rather, users must copy, clip or save webpages from the browser to another application in order to then again access using other applications to add notes, drawings, and so forth. Therefore, these notes are now saved in the other applications and as such access to these notes is limited to the respective applications that are used to save the notes. Accordingly, these conventional techniques force a user to navigate between applications to access webpages and then gain access to notes regarding the webpages, which is inefficient and frustrating to the users. Additionally, conventional techniques do not support efficient techniques to share these notes, do not support techniques to add notes to live webpages that would allow users to resize the window or allow the users to follow links in the webpage.

Techniques involving control of access and management of browser annotations are described. In one or more implementations, the browser is configured to support inclusion of annotations natively within the browser as part of the webpage thereby forming an annotated webpage. The annotated webpage is accessible in a variety of different ways, e.g., as part a bookmark (e.g., favorites), reading list, a dedicated notes section, and so on. For example, the annotated webpage is formed by capturing of an image of the webpage, annotations made in relation to the image, and hypertext markup language (HTML) associated with the webpage.

This capture supports a variety of different functionality, including anchoring of annotations to a webpage to support a variety of different layouts such that the annotations reflow correctly when the layout of the web page changes as well as support use of hyperlinks within the webpage. Additionally, the annotated webpage is shareable with other users, such as through storage as by a service provider and sharing of a link to a network address of the service provider through which the annotated webpage is accessible. Further functionality includes control of display of annotations in relation to the captured webpage, automatic display of an option to view previously made annotations when navigating back to a particular webpage, providing an option to post the annotations back to a user account of a network service (e.g., a user profile of a social network), and so forth. Additionally, the annotations may be incorporated into a general share flow. For example, users may share annotations after created. Another possibility is that user may select a webpage to be shared and a destination with which to share the webpage and then be presented with an opportunity to annotate the webpage before the share is completed. Further discussion of these and other functionality is described in the following sections and shown in corresponding figures.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

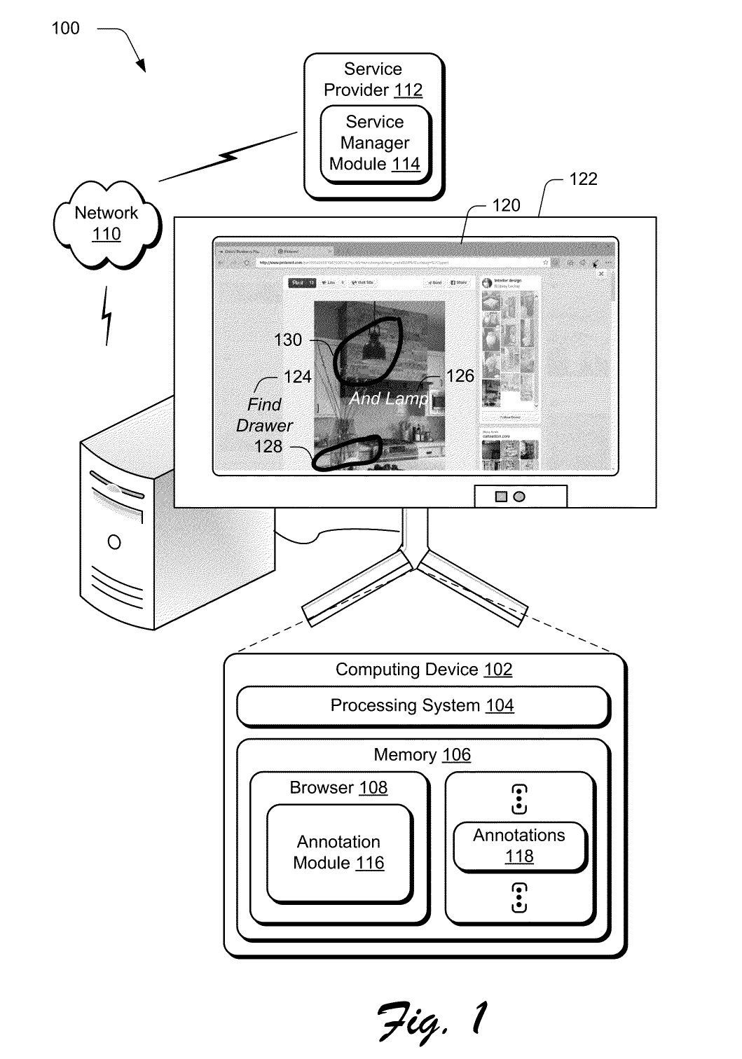

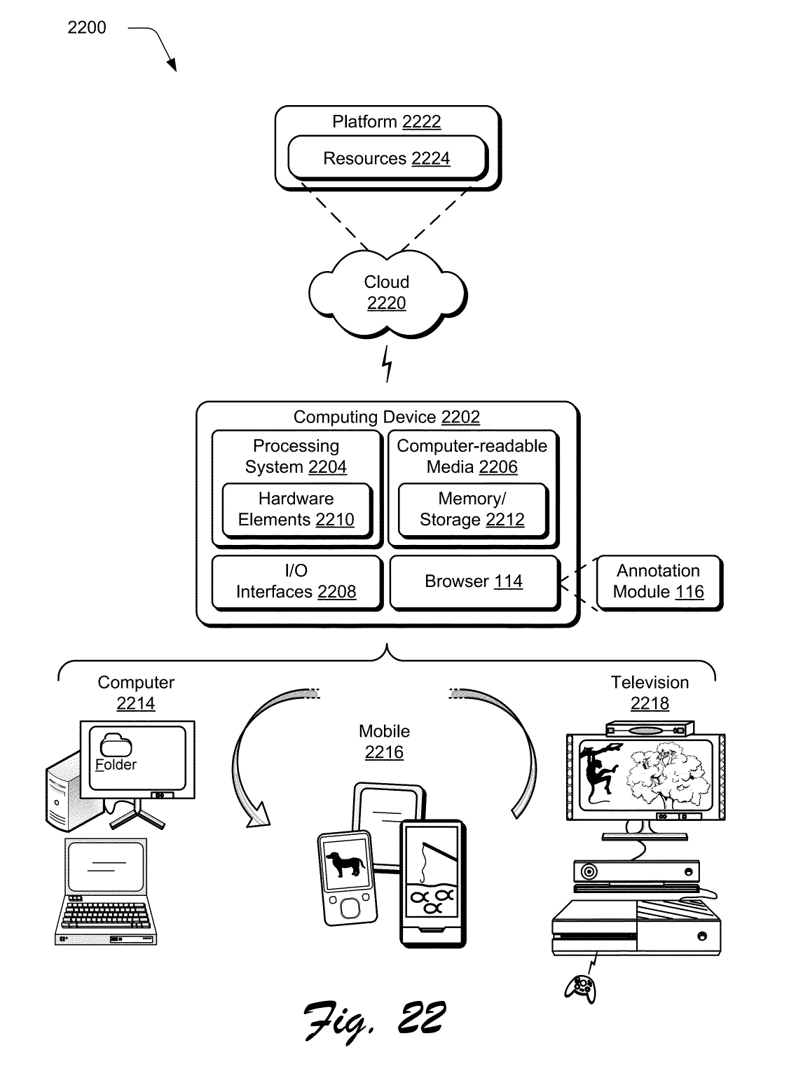

FIG. 1 illustrates an operating environment in accordance with one or more embodiments, generally at 100. Environment 100 includes a computing device 102 having a processing system 104, one or more computer-readable storage media, an example of which is illustrated as memory 106. Computing device 102 can be implemented as any suitable computing device such as, by way of example and not limitation, a desktop computer, a portable computer, a handheld computer such as a personal digital assistant (PDA), mobile phone, tablet computer, and the like. One of a variety of different examples of a computing device 102 is shown and described below in FIG. 22.

The computing device 102 of FIG. 1 is also illustrated as including a browser 108, e.g., a web browser, which may be implemented using one or more modules as further described below. The browser 108 is representative of functionality that is configured to navigate via the network 110. Although the network 110 is illustrated as the Internet, the network may assume a wide variety of configurations. For example, the network 110 may include a wide area network (WAN), a local area network (LAN), a wireless network, a public telephone network, an intranet, and so on. Further, although a single network 110 is shown, the network 110 may be configured to include multiple networks.

The browser 108, for instance, may be configured to navigate via the network 110 to interact with webpages available from one or more web servers of a service provider 112 as well as communicate data to the one or more servers of the service provider 112 through communication with a service manager module 114, e.g., perform downloads and uploads. The service manager module 114 is representative of functionality to implement one or more services that are accessible via the network 110. Examples of such services include email, web pages, photo sharing sites, social networks, content sharing services, media streaming services, and so on.

The browser 108 in the illustrated example is also shown as including an annotation module 116. The annotation module 116 is representative of functionality of the browser 108 regarding annotations 118 that are made via and accessible by the browser 108. A user, for instance, may cause the browser 108 to navigate to a webpage 120 accessible via the network 110, an example of which is displayed in a user interface on a display device 122 of the computing device 102. Annotations 118 are then made by a user through interaction supported by the annotation module 116 of the browser 108. Examples of the annotations 118 include text (e.g., Find Drawer and Lamp 124, 126) and free form drawings 128, 130 that circle the corresponding items. A variety of other types of annotations 118 are also contemplated as described in greater detail in the following.

In this way, the browser 108 provides native support for annotations 118 over any webpage with ink, typed notes, stickers, shapes, glitter pens, and so forth. Annotations 118 may also be anchored to the webpage, so annotations will correctly reflow when resizing or changing the layout of a webpage. Navigating back to a webpage may also cause the browser 108 to permit a user to see any annotations previously made for that given webpage. Annotations 118 are accessible in a variety of ways, such as saved to favorites and/or reading list directly in the browser 108 for efficient access. Users can also cause sharing of the annotations, such as through the service provider 112. Further, when annotating webpages available from a social network or other network service, the user can quickly post back to the profile that is associated with the webpage. A variety of other functionality is also contemplated, such as to support user purchase of additional techniques to annotate webpages, such as sticker packs (e.g., associated with a particular movie), glitter pens, and so forth.

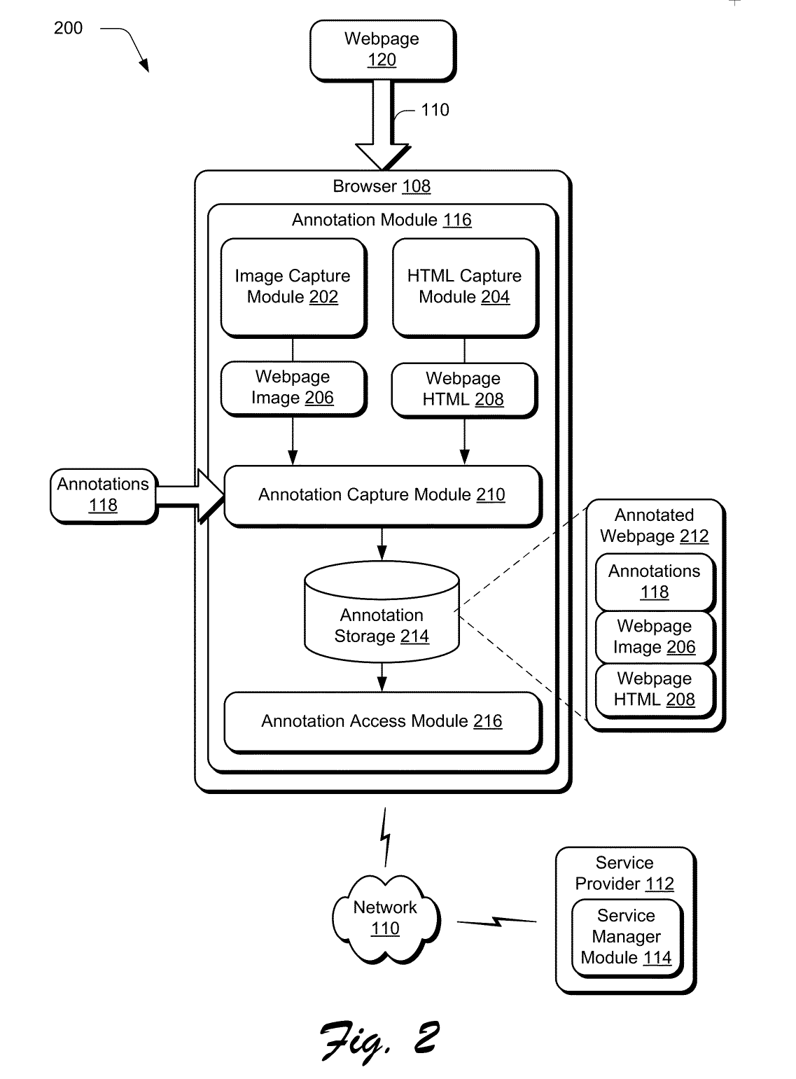

FIG. 2 depicts a system 200 in an example implementation in which the annotation module 116 of the browser 108 is shown in greater detail. In this example, the browser 108 is illustrated as obtaining a webpage 120 via the network 110. A user then initiates functionality of the annotation module 116 to make annotations to the webpage 120. For example, the user may select an option in a user interface, simply begin a freeform drawing, add text, and so on which causes the annotation module 116 to automatically capture these inputs as annotations 118, and so on.

The annotation module 116 includes an image capture module 202 and an HTML capture module 204. The image capture module 202 is representative of functionality to capture webpage images 206 of content of the webpage 120. This is performable in a variety of ways, such as to capture images of the webpage 120 as a whole, images of content referenced by live HTML of the webpage 120, and so on. In this way, the webpage image 206 acts to “freeze” the webpage 120 in a currently viewed state such that content of the webpage is not updated. Other examples are also contemplated, however, in which live updates are maintained.

The HTML capture module 204 is representative of functionality of the browser 108 to capture webpage HTML 208 of the webpage 120, which may also including cascading style sheet (CSS) information. The HTML capture module 204, for instance, may capture HTML elements from HTML files that are used to define a layout of images, objects, text, scripts, links, and so on included in the webpage 120.

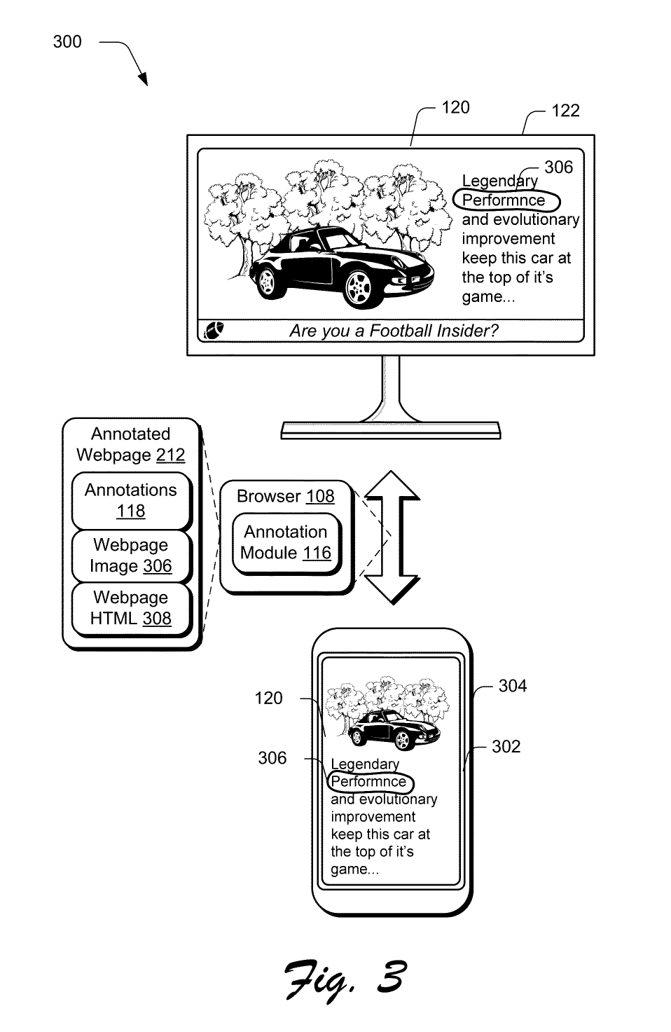

In this way, the captured webpage HTML 208 is usable by the annotation module 116 to support a variety of different functionality. For example, links included in the webpage 120 may be preserved through “hot zones” included in the webpage image 206. Thus, users are able to select (e.g., “click”) links even though content within the webpage is made static (e.g., “frozen”) as part of the webpage image 206 as described above. This may also be utilized to support text selection in the image such that users can select and modify (e.g., highlight) text that is part of the webpage image 206. Other examples including anchoring of annotations and support for multiple layouts as further described in relation to FIG. 3.

The annotation module 116 is also illustrated as including an annotation capture module 210 that is representative of functionality to capture annotations 118 made by a user through interaction with a display of the webpage 120 by the browser 108. A variety of annotations may be input by a user, such as a freeform drawing, typed text, insertion of additional images, audio recordings, multimedia, highlighters, glitter pens, and so forth. In this way, a user may provide inputs that are used by the annotation module 116 to transform the webpage 120 into an annotated webpage 212 that is formed using the captured annotations 118, webpage image 206, and webpage HTML 208, which is illustrated as stored in annotation storage 214 associated with the browser 108.

An annotation access module 216 is also included as part of the annotation module 116. The annotation access module 216 is representative of functionality of the browser 108 to control access to the annotated webpage 212 via the browser 108. A variety of different types of access are supportable by the annotation access module 216. For example, the annotation access module 216 is configured to upload the annotated webpage 212 to a service provider 112 that is accessible remotely via a network 110. The service provider 112, for instance, may be configured as a data sharing service such as OneDrive® or other data sharing service that maintains an account associated with a user of the browser 108. This may be done automatically and/or responsive to a request to share the annotated webpage 212.

When such a request is received, the annotation access module 216 forms a communication to be delivered to a computing device associated with a user that is to be given access to the annotated webpage 212. The communication includes a link to a network address of the service provider 122, via which, the annotated webpage 212 is available. In this way, resources of the computing device 102, network 110, and other computing device are conserved.

In another example of access control, the annotated access module 216 is configured to assist sharing of the annotated webpage 212. The webpage 120, for instance, may be obtained using a uniform resource locator that indicates both a website from which the webpage 120 is obtained and also a user account of the website, such as www.website.com/user_account, such as for a social network and user profile of the social network.

Accordingly, the annotation access module 216 may identify the website and user account and thus provide an option that is selectable by a user (e.g., a button displayed in a user interface, gesture, and so on) to post the annotated webpage 212 back to that user account, e.g., the user's profile in the social network. In this way, the annotation access module 216 is usable to increase efficiency of communications back to a particular user that involve a webpage 120 of that user.

In yet another example of access control, the annotation access module 216 is configured to detect when a user has navigated to a URL of a webpage 120 that the user has annotated, e.g., an annotated webpage 212 version of the webpage 120 is available via annotation storage 214. When so detected, the annotation access module 216 may provide an option that is user selectable (e.g., (e.g., a button displayed in a user interface, gesture, and so on) to cause output of the annotations 118. This may be performed in conjunction with a currently obtained webpage, use the webpage image 206 and webpage HTML 208 captured for a previous version of the webpage 120, and so on. An option is also includable to control display of the annotations 118, e.g., whether or not to cause display of the annotations 118 with the newly obtained webpage, the webpage image 206, and so forth. In this way, users are automatically and efficiently reminded that annotations 118 already exist for the webpage 120 and may choose to view or not view the annotations 118 as desired.

Other access control examples are also contemplated, such as to share the annotations 118 and/or the annotated webpage 212 with other applications executed by the computing device 102, e.g., as part of a system share contract, with web services implemented by service providers 112, save locally in the annotation storage 214 in memory 106 of the computing device 102, remotely via the network 110 as previously described, and so forth.

FIG. 3 depicts an example implementation 300 showing anchoring of annotations 118 in the annotated webpage 212. As previously described, the webpage HTML 308 is used to describe a structure of the webpage 120, such as to describe positioning of elements in relation to each other. In this example, the annotation module 116 “freezes” live HTML such that the elements in the webpage 120 may reflow between different layouts, but content of the elements (e.g., images accessible via links) do not update.

In the illustrated example, the display device 122 as configured in a typical desktop configuration is shown along with a display device 302 of a computing device 304 having a mobile form factor, e.g., a mobile phone, tablet, and so forth. Because the aspect ratio, size, and/or resolution of the display devices 122, 302 is different, the layout specified by the webpage HTML 308 is different for display by the display devices 122, 302. For example, for display device 122 an image and text in the webpage 120 are aligned horizontally and an advertisement is positioned at a bottom of the display.

On the other hand, for display device 302 the image and the text are vertically aligned and the advertisement is not shown, e.g., due to the limited display area of the display device 302. Other examples are also contemplated, such as to support different layouts based on portrait or landscape views of the display device 302 of the computing device 304 that has the mobile form factor, to support resizing of a window in a user interface, and so forth. Thus, the annotated webpage 212 supports rich display by the annotation module 116 in this example.

Anchoring techniques are also employable by the annotation module 116 such that annotations 118 follow a layout and thus are able to reflow between different layouts. For example, based on a type of annotation 118 being made (e.g., circling a word, jotting down a note, drawing an arrow), the annotations 118 are configured to follow a reflow of a layout of the annotated webpage 212.

A user, for instance, may input an annotation 306 to circle a misspelled word in the webpage 120. In response, the annotation module 116 (e.g., the annotation capture module 210 of FIG. 2) determines a relative position of the annotation 306 in relation to one or more elements included in the webpage, e.g., the text in this example, but images, tables, and so on are also contemplated. This may be performed in a variety of ways, such as to leverage the webpage HTML 308 describing the structure of the webpage 120, identify portions of the webpage image 306, and so forth. Accordingly, when the layout is changed (e.g., due to a window resize and so forth as previously described) the annotation module 116 locates the relative position and leverages the captured HTML 208 to cause the annotation 306 to be displayed at that position. In this way, the annotation 306 is configured to reflow with changes to the layout in an intuitive manner that supports use of the annotations on a variety of different types of display devices and even views supported by those devices. Additional examples are also contemplated as further described in the following and shown in corresponding figures.

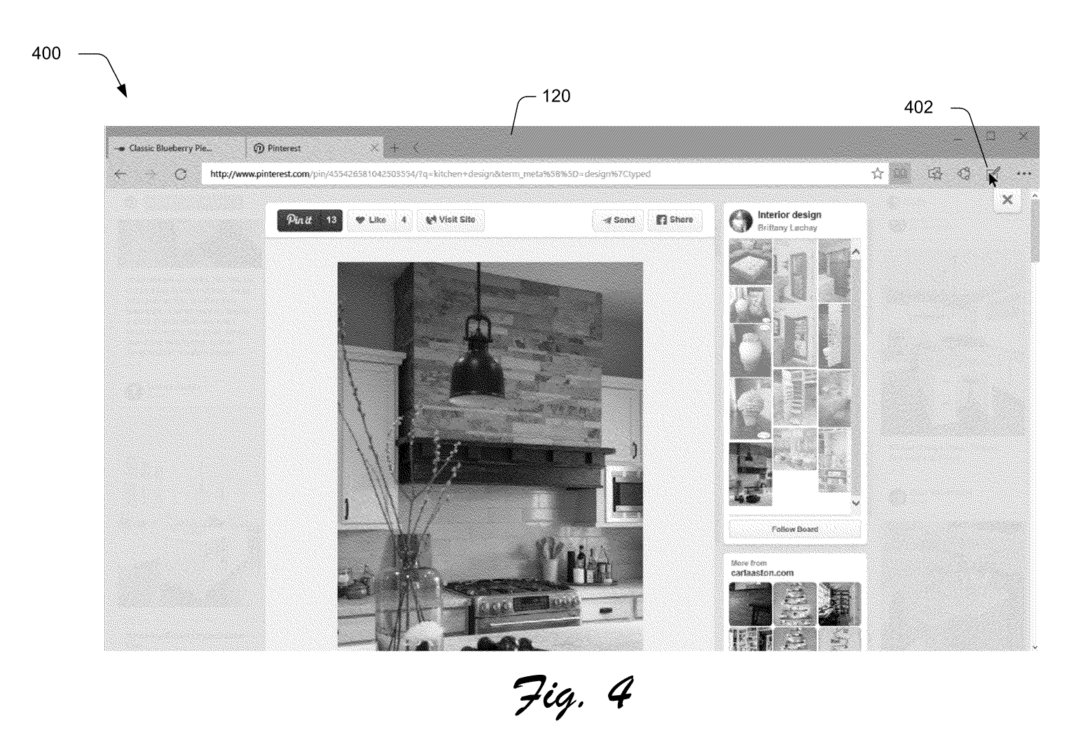

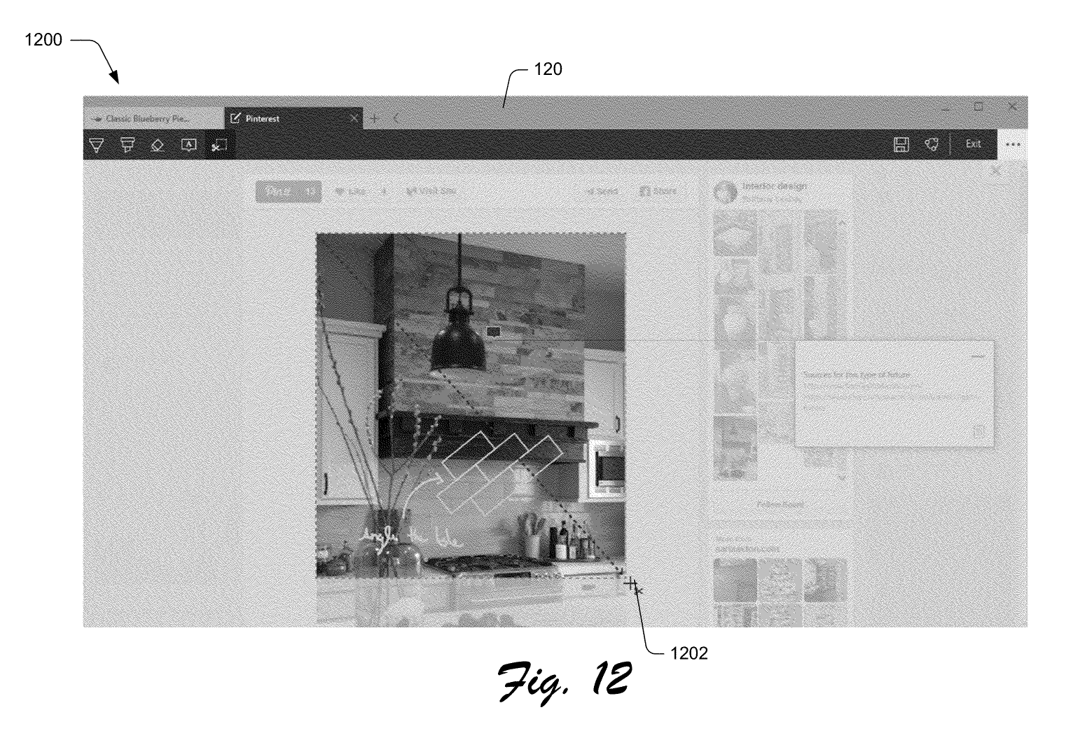

FIGS. 4-19 depict examples of user interfaces 400-1900 that exhibit user interaction with functionality of the annotation module 116 of FIGS. 1-3 to make, share, and access annotations via a browser. At the user interface 400 of FIG. 4, a user uses a cursor control device to select an option 402 to cause the browser 108 to enter a mode to accept annotations. In response, the annotation module 116 uses the image capture module 202 and the HTML capture module 204 to capture a webpage image 206 and webpage HTML 208, thereby “freezing” the webpage 120.

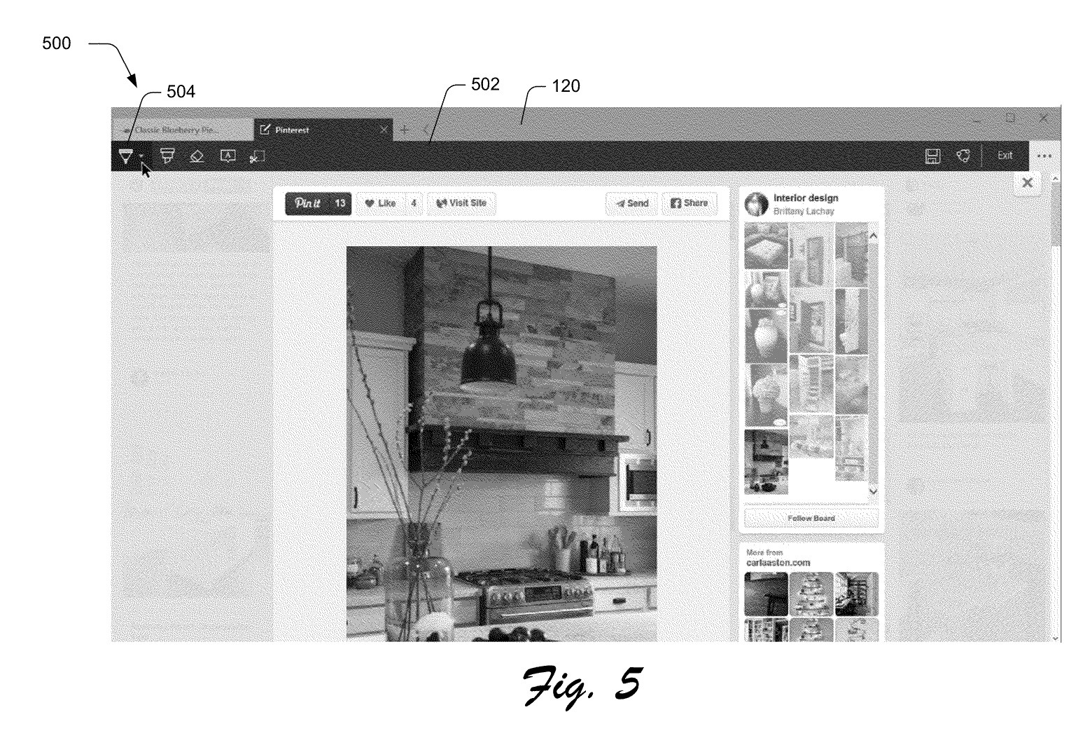

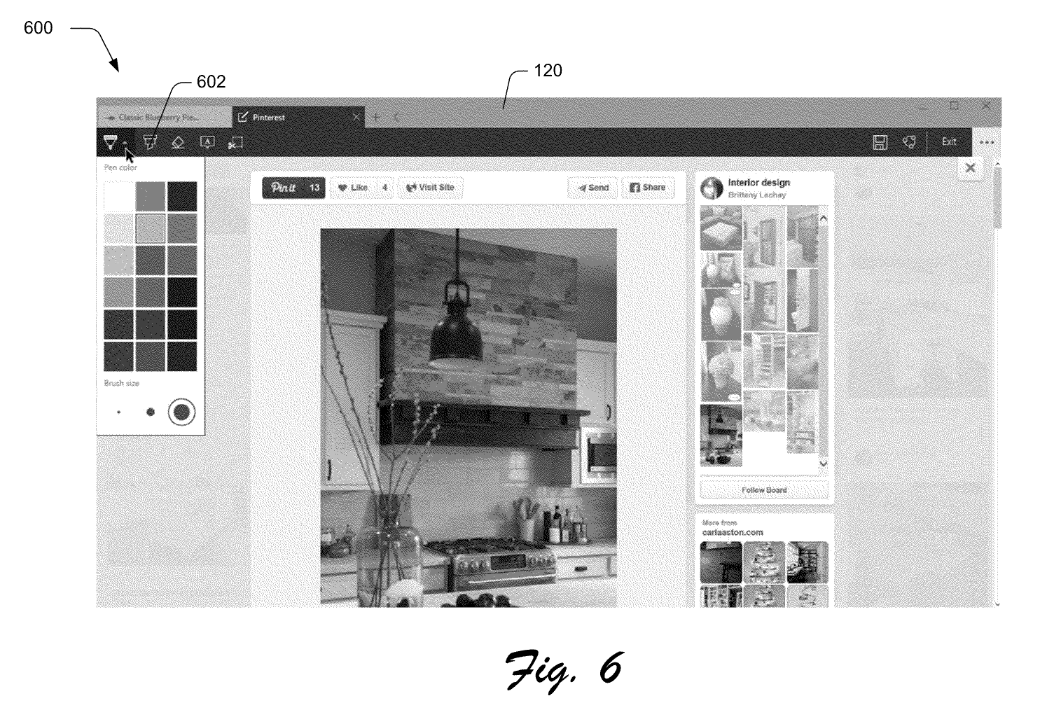

The annotation module 116 also causes output of a toolbar 502 in the user interface 500 as shown in FIG. 5 having options of tools that are usable to provide inputs as annotations to the webpage 120. In the illustrated example, the user selects an option 504 relating to a pen tool such that the user may draw ink on the webpage 120 in a freeform manner. Selection of the option 504 causes output of a menu 602 as shown in the user interface 600 of FIG. 6 having options to specify a pen color and size.

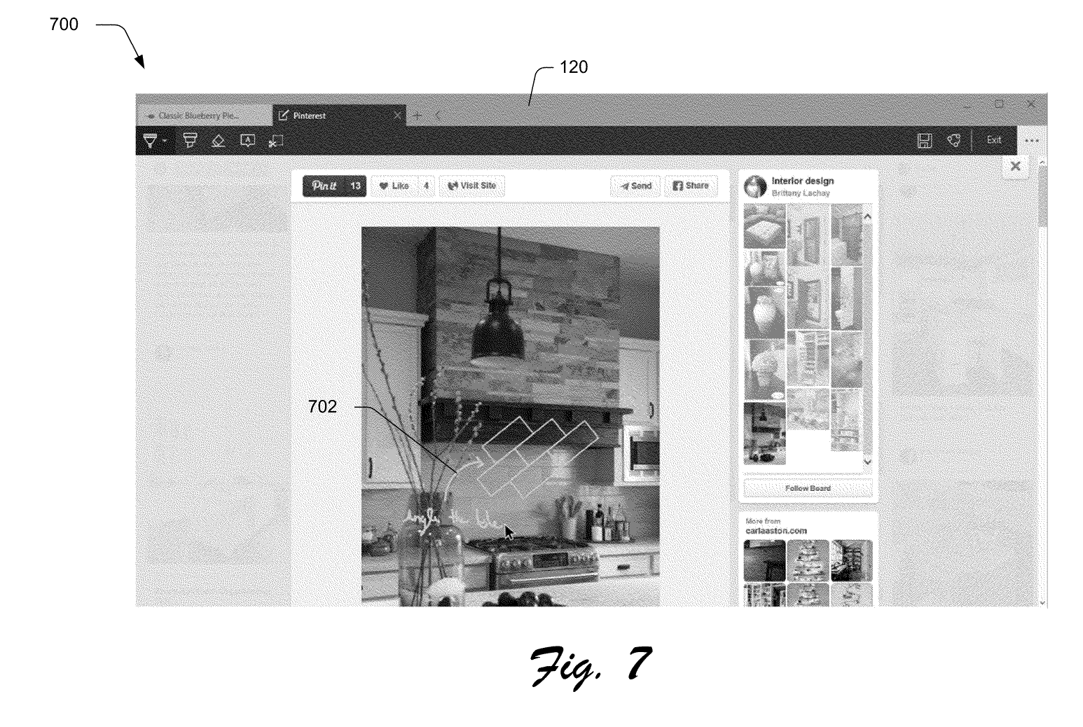

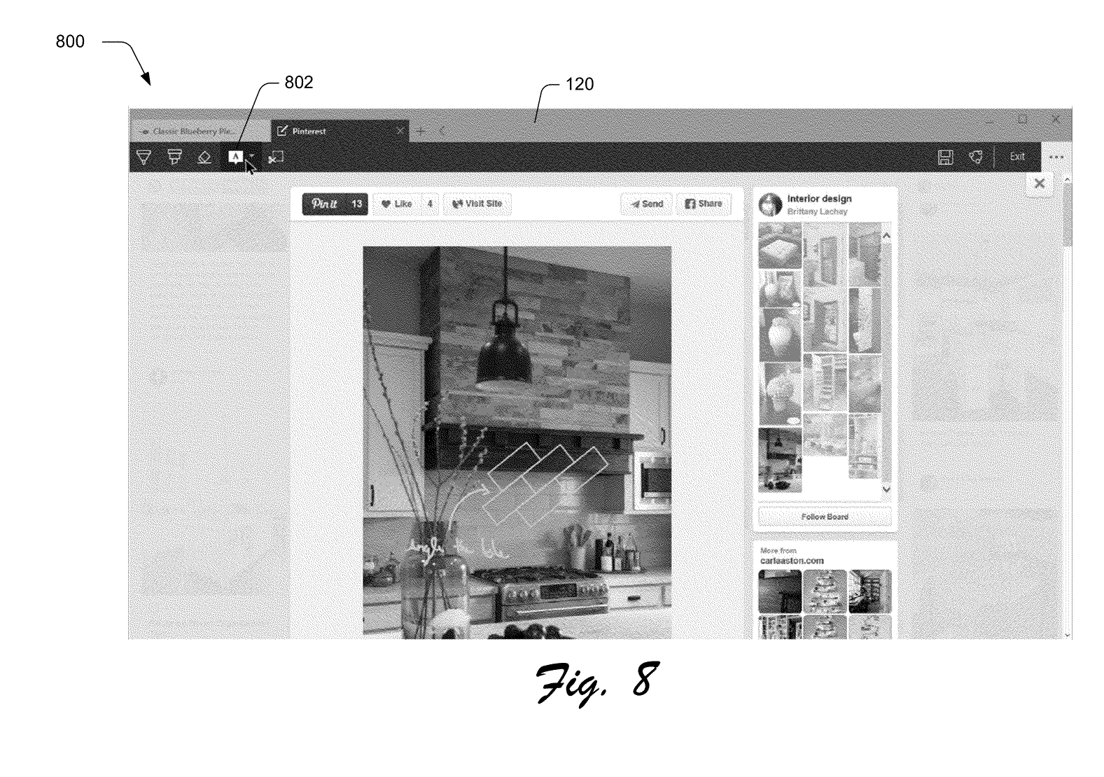

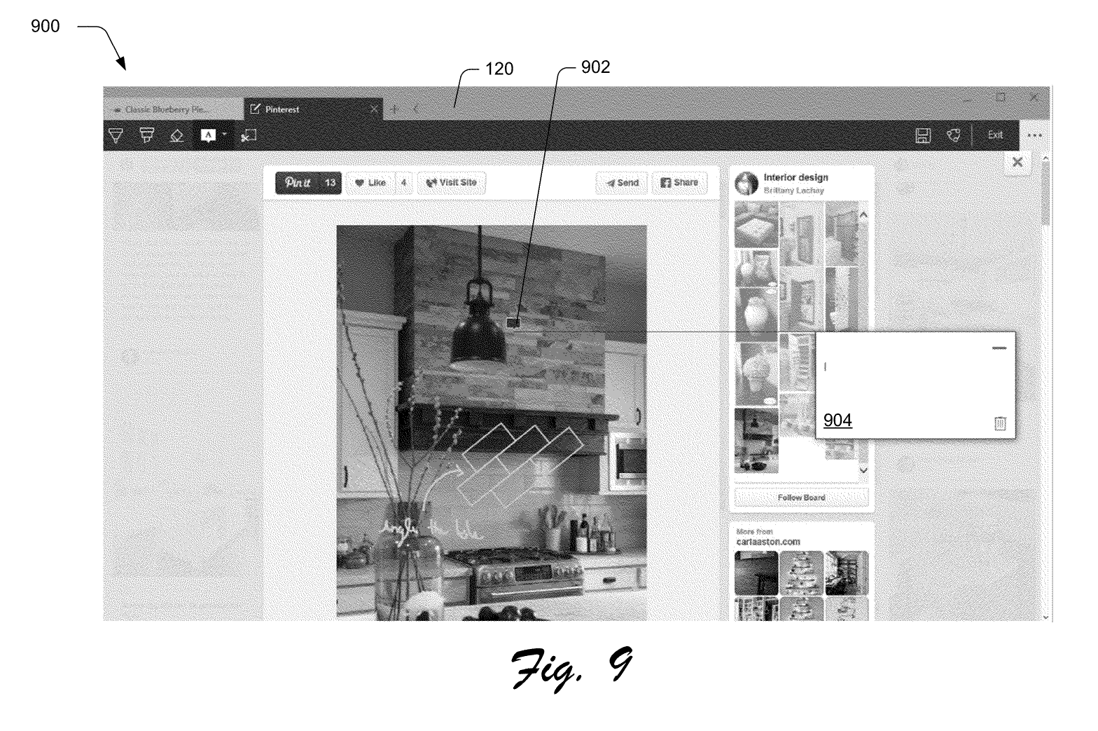

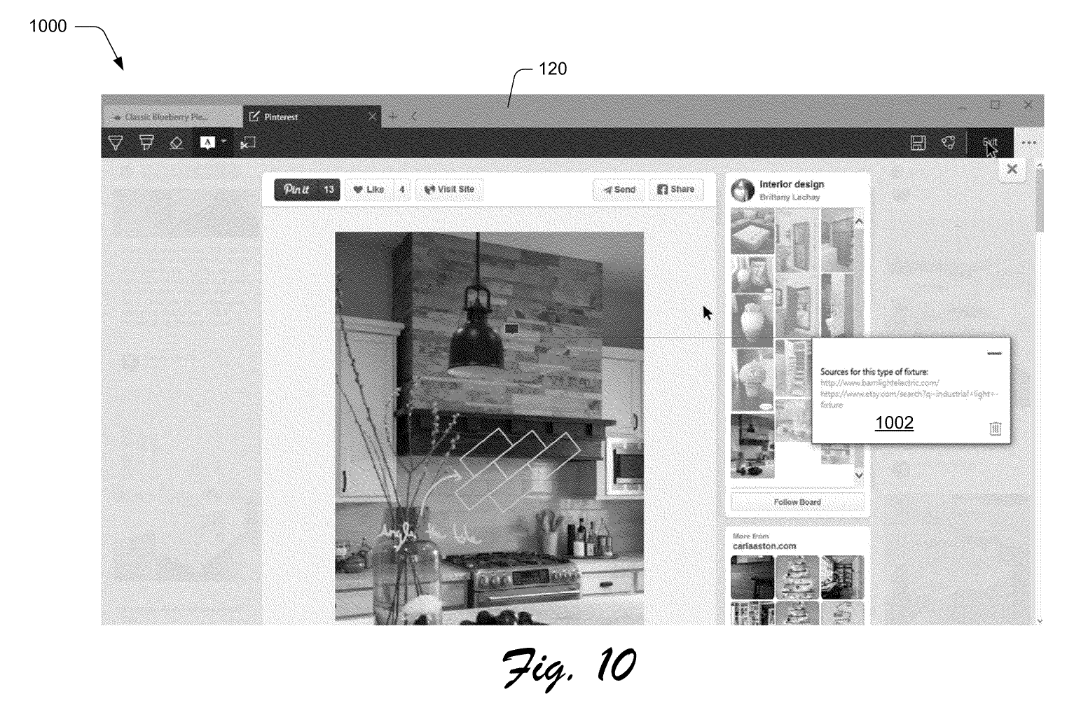

The user interface 700 of FIG. 7 includes examples of annotations 702 that are drawn on the webpage 120, which include text and shapes including a note to have the bricks in the background positioned at an angle. In the user interface 800 of FIG. 8, a user selects an option 802 to include a text box to enter text as an annotation to the webpage 120. As shown in the user interface 900 of FIG. 9, after selection of the option a user the user indicates a relative location 902 in the webpage 120 that is to be a subject of the text box, which causes output of the text box 904 via which the user may enter one or more comments. The user interface 1000 of FIG. 10 includes an example 1002 of one such comment, which is text and a hyperlink for a source of the lamp fixture.

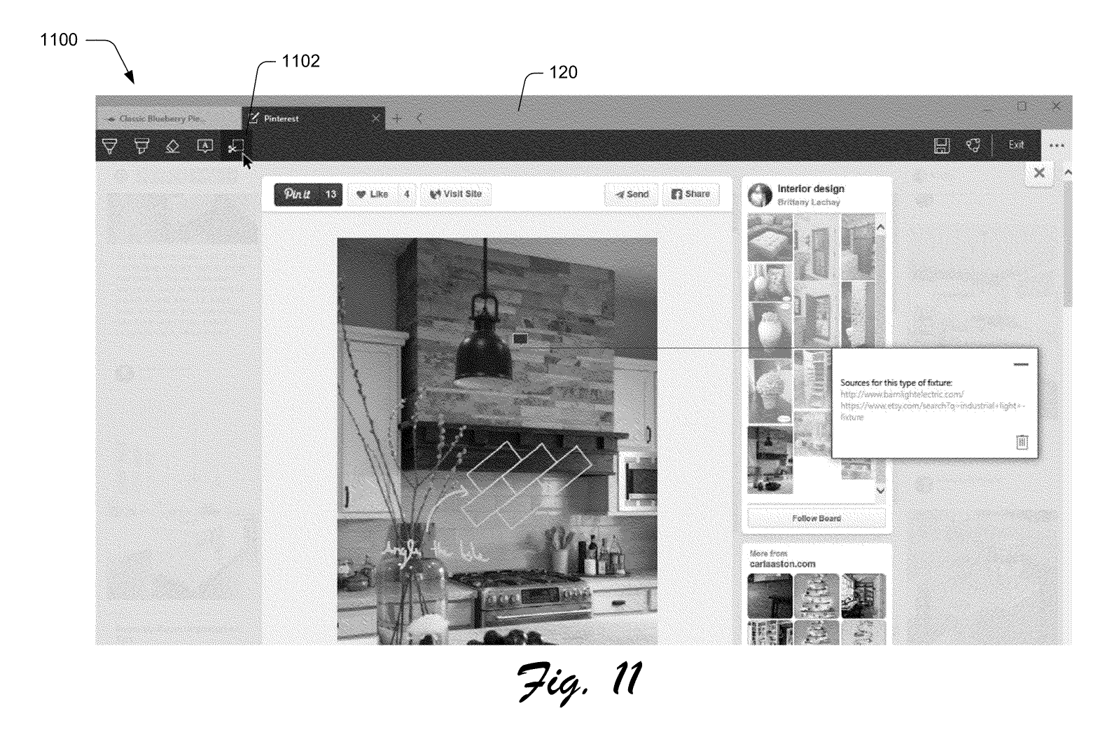

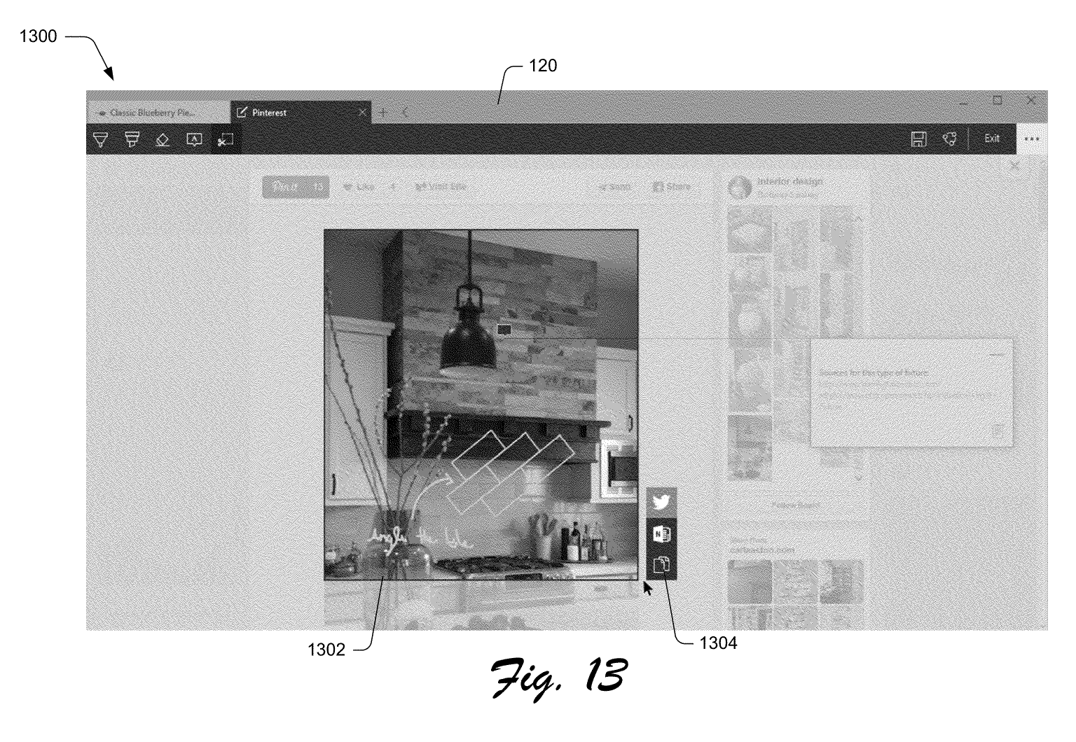

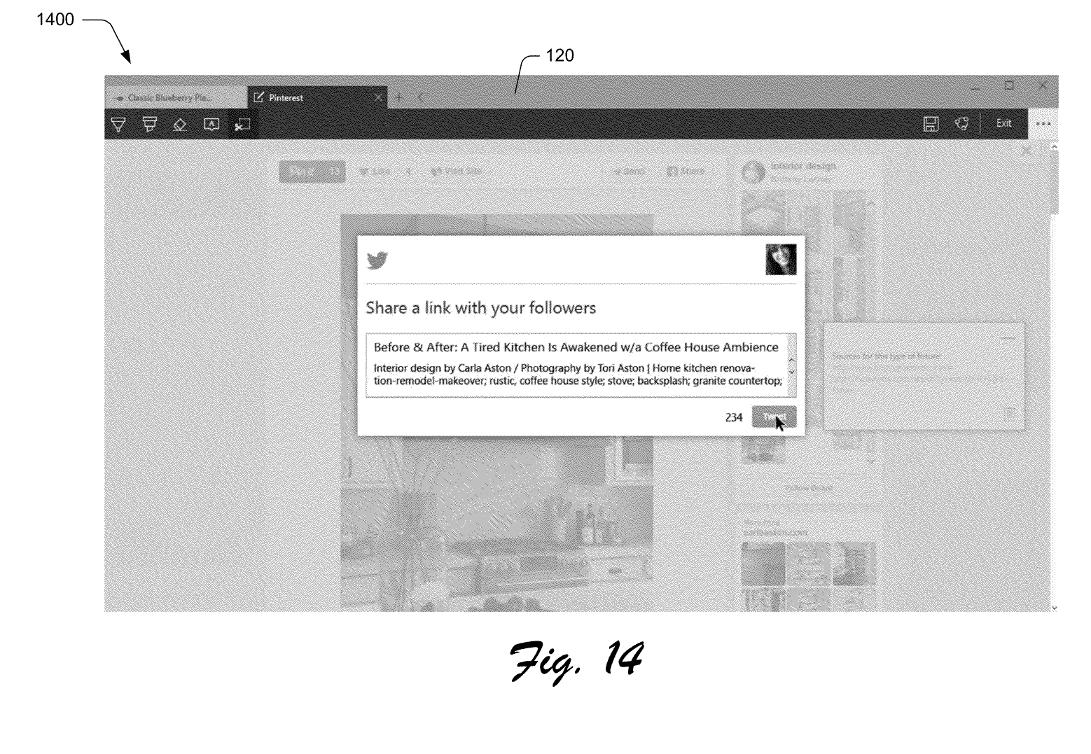

In the user interface 1100 of FIG. 11, an option is selected by a user to save a portion (e.g., a clip) of the webpage 120. Once selected, a user may perform a click and drag operation 1202 to specify a rectangle defining the portion to be selected. Once selected 1302 as shown in the user interface 1300 of FIG. 13, options 1304 are output that are usable to specify how the selection 1302 is to be shared, such as with a social network, sent to a note taking or other application, copied, and so forth. One such example is shown in the user interface 1400 of FIG. 14, in which a user has chosen to share a link with followers in a social network. A variety of other examples are also contemplated.

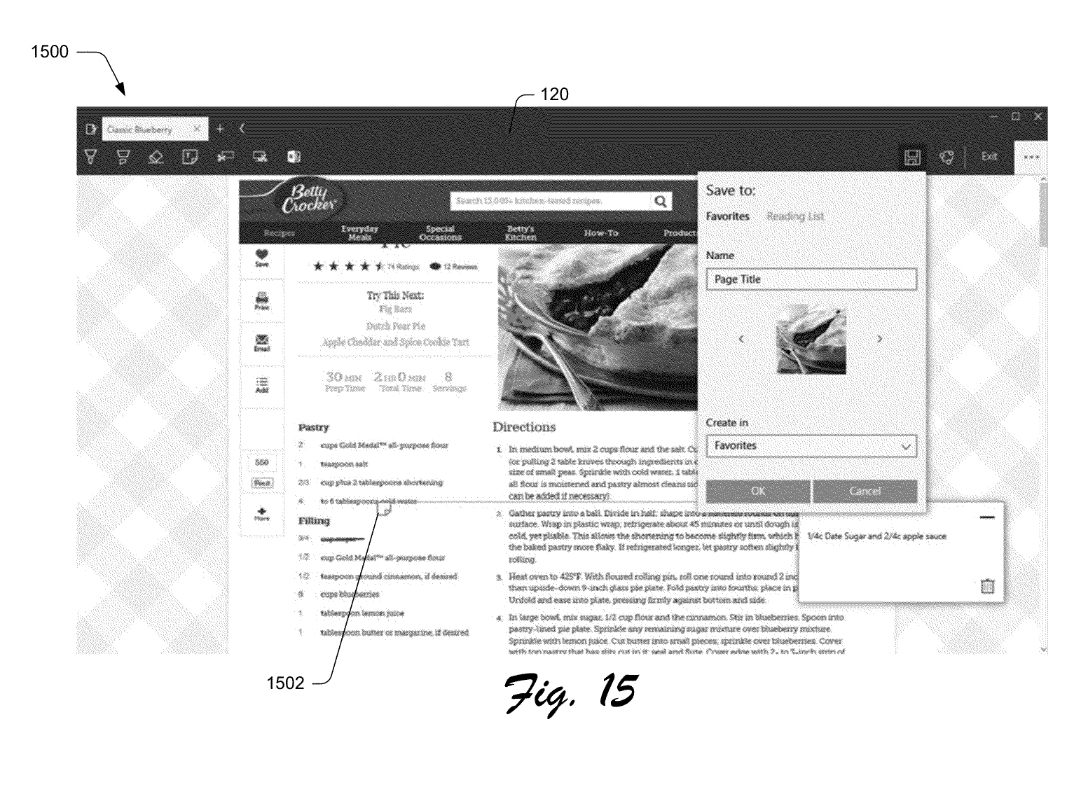

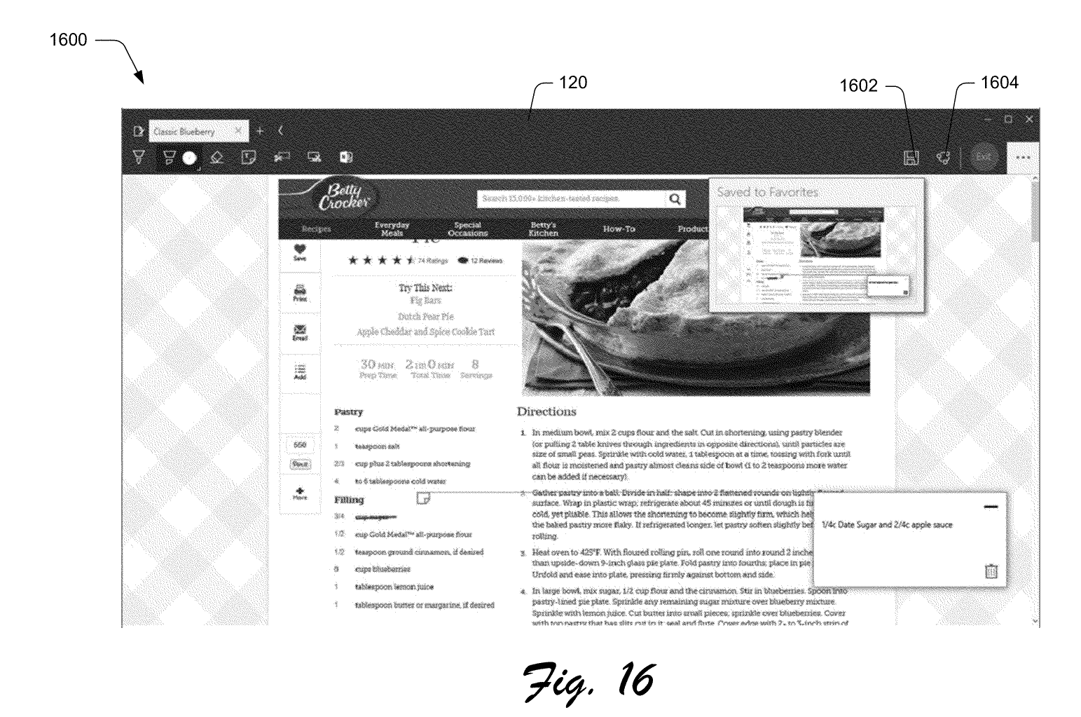

FIG. 15 is a user interface 1500 having another example of the webpage 120 as including annotations. As illustrated, this includes anchoring of annotations 1502 to a relative location as previously described in relation to FIG. 3 such that different layouts and reflow between the layouts is supported. In FIG. 16, a user interface 1600 is illustrated in which a user has selected an option 1602 to save the annotated webpage to “favorites.” Favorites is a location in the user interface that, when selected, causes output of a menu that includes representations of favorites saved by the user. For example, if a user annotations a webpage and saves it as a bookmark (e.g., to favorites) a subsequent attempt to access the website may provide an option to option annotations as further described below. Other examples are also contemplated, such as a reading list having consumption functionality to facilitate natural reading of documents (e.g., continue where left off, dictionary, etc.), and so forth.

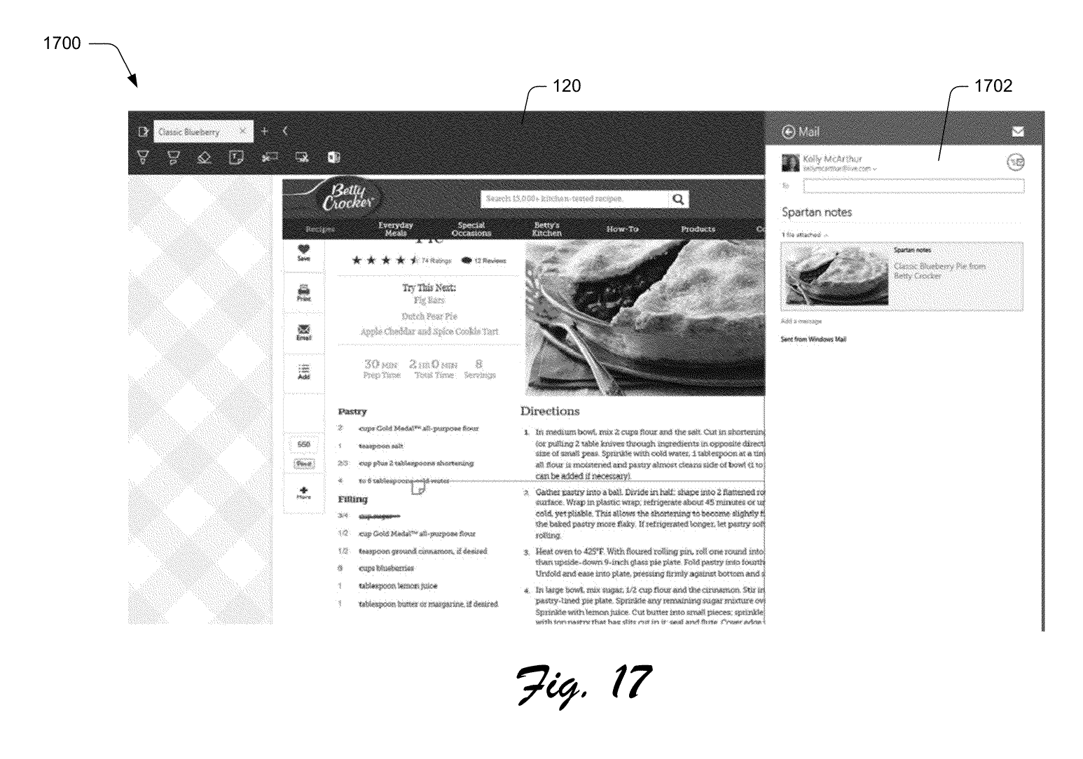

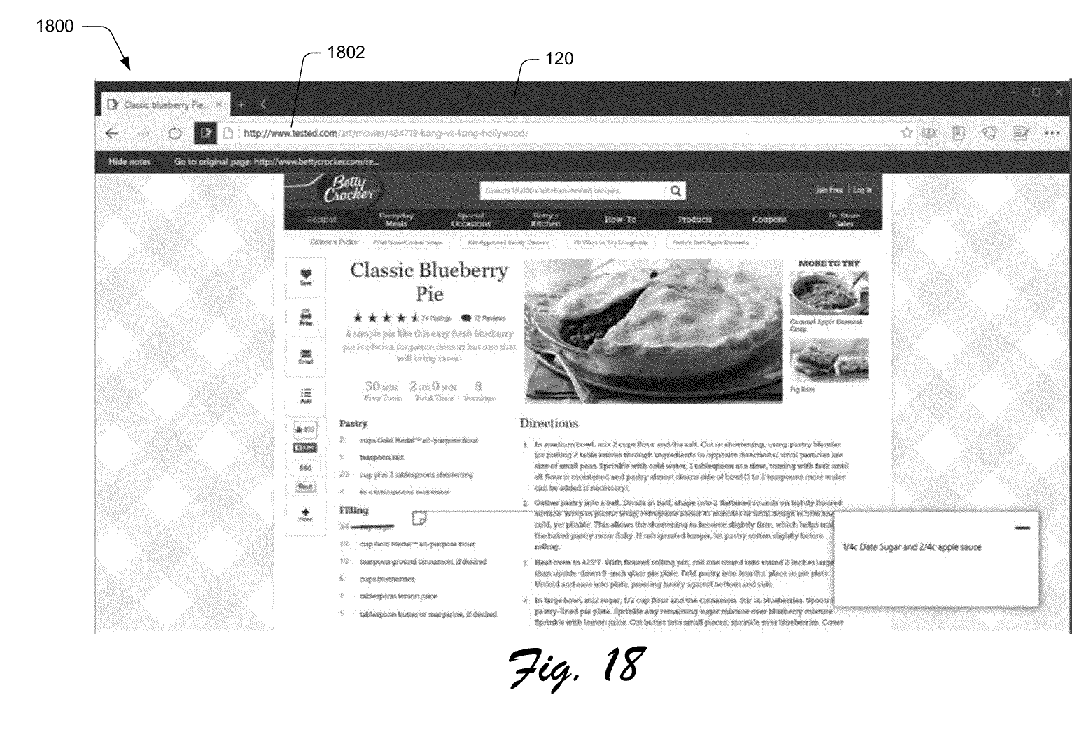

The user interface 1600 of FIG. 16 also includes an option 1604 to share the annotated webpage. An example of selection of this option is shown in the user interface 1700 of FIG. 17, in which an option is provided to email the annotated webpage to another user. As previously described, this may be performed through formation of a communication having a link to a network address of a service provider 112 via which the annotated webpage 212 is accessible. An example of this is shown in the user interface 1800 of FIG. 18, in which a URL of the service provider 112 is used to access the annotated webpage 212, which is different than the URL from which the webpage originated as shown through comparison with FIG. 17. Other examples are also contemplated, such as to transmitted the annotated webpage 212 directly, an image having the annotations 118 and the webpage image 206, and so forth.

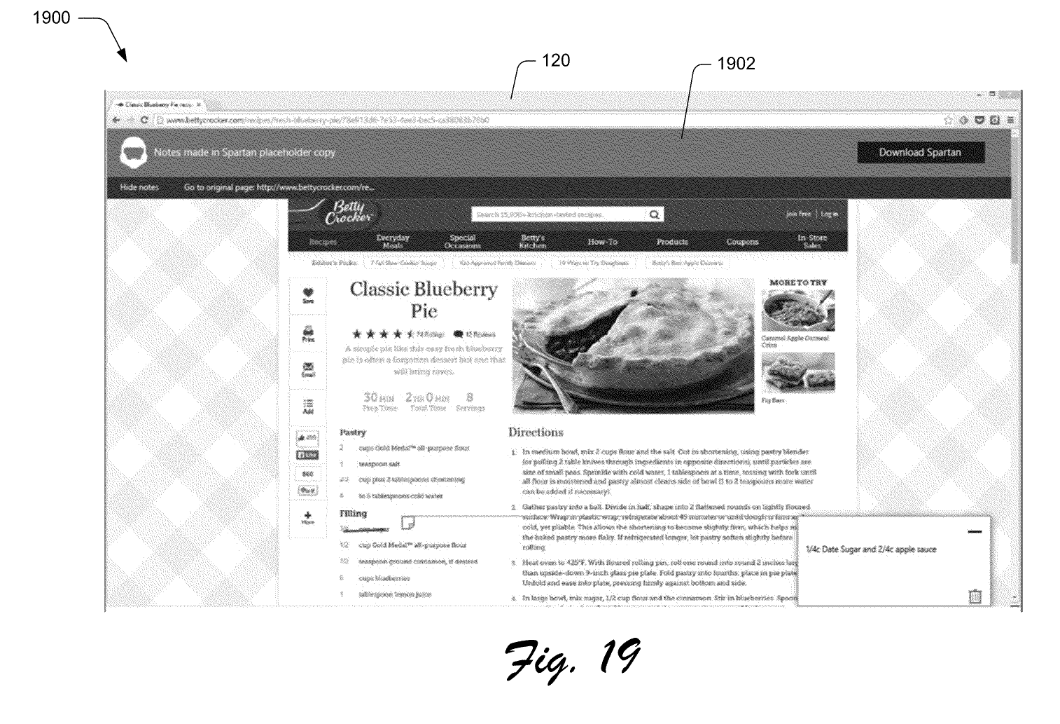

FIG. 19 includes a user interface 1900 showing another example of sharing, which in this instance causes communication of the annotated webpage 212 to another application executed by the computing device 102, e.g., a note taking application in this instance. Thus, the techniques described herein support a variety of different functionality usable to control access and manage browser annotations, further discussion of which is described in relation to the following procedures.

Example Procedures

The following discussion describes access and management control techniques of browser annotations that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the figures described above.

Functionality, features, and concepts described in relation to the examples of FIGS. 1-19 may be employed in the context of the procedures described herein. Further, functionality, features, and concepts described in relation to different procedures below may be interchanged among the different procedures and are not limited to implementation in the context of an individual procedure. Moreover, blocks associated with different representative procedures and corresponding figures herein may be applied together and/or combined in different ways. Thus, individual functionality, features, and concepts described in relation to different example environments, devices, components, and procedures herein may be used in any suitable combinations and are not limited to the particular combinations represented by the enumerated examples.

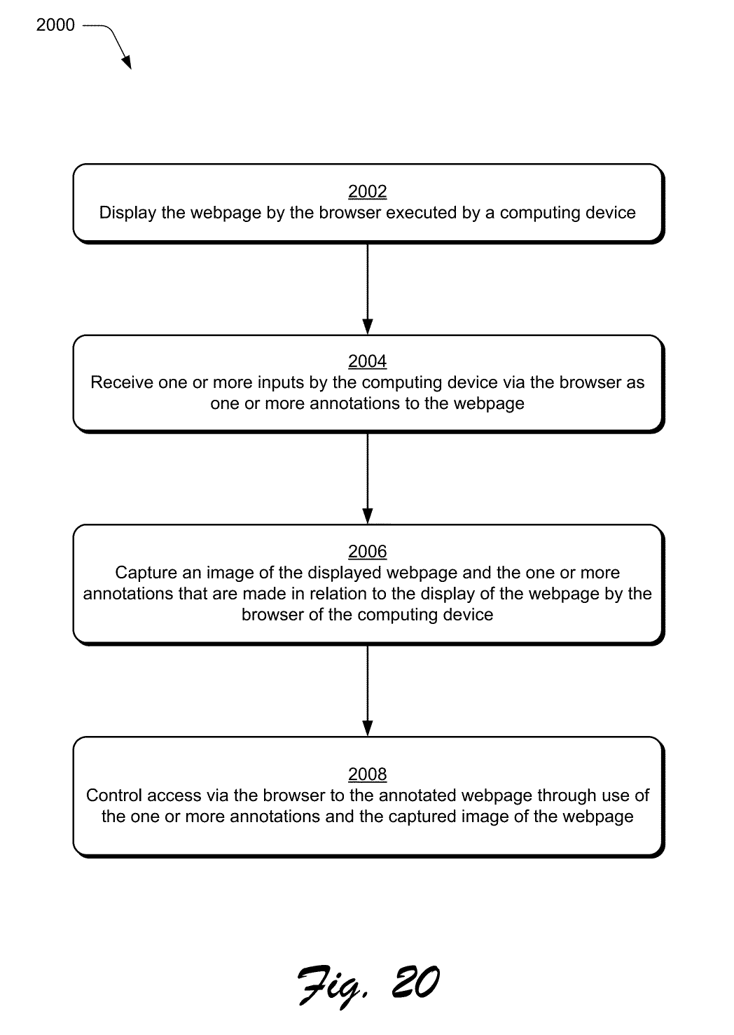

FIG. 20 depicts a procedure 2000 in an example implementation to control and manage access to annotations made via a browser to transform a webpage. The procedure 2000 includes display of the webpage by the browser executed by a computing device (block 2002). The browser 108, for instance, may navigate to a webpage via the network 110 and download it for viewing in a user interface of the computing device 102.

One or more inputs are received by the computing device via the browser as one or more annotations to the webpage (block 2004). The inputs may be provided by a user in a variety of ways, such as via a cursor control device, keyboard, touchscreen gesture, gesture captured using a camera, a spoken utterance, a captured video, input image or other media, and so forth.

An image is captured of the displayed webpage and the one or more annotations that are made in relation to the display of the webpage by the browser of the computing device (block 2004). The image capture module 202, for instance, generates a webpage image 206 thus “freezing” live HTML of the webpage 120, such as scripts, links to active content, and so forth.

Access via the browser to the annotated webpage is controlled through use of the one or more annotations and the captured image of the webpage (block 2006). In this way, a user may view and make annotations without navigating away from the browser 108, thereby improving user efficiency and conserving resources of the computing device 102. A variety of other examples are also contemplated.

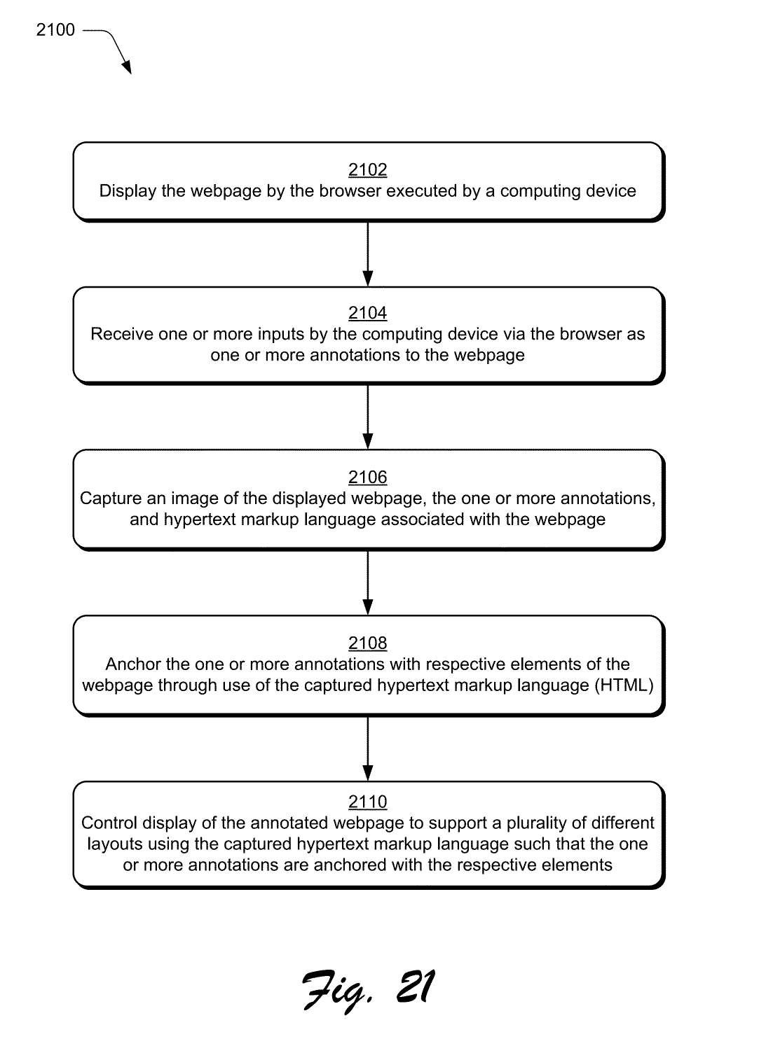

FIG. 21 depicts another procedure 2100 in an example implementation to control and manage display of annotations made via a browser to transform a webpage. The procedure 2100 includes displaying the webpage by the browser executed by a computing device and receiving one or more inputs by the computing device via the browser as one or more annotations to the webpage (block 2102) and capturing an image of the displayed webpage, the one or more annotations, and hypertext markup language (HTML) associated with the webpage (block 2104). For example, the annotation module 116 uses the image capture module 202, HTML capture module 204, and annotation capture module 210 to capture webpage images 206, webpage HTML 208, and annotations 118, respectively.

The one or more annotations are anchored with respective elements of the webpage through use of the captured hypertext markup language (HTML) (block 2106). The annotation capture module 210, for instance, may determine a relative location that is associated with the annotation, such as particular text, images, or other elements of the webpage at that relative location.

Display of the annotated webpage is controlled to support a plurality of different layouts using the captured hypertext markup language such that the one or more annotations are anchored with the respective elements (block 2108). In this way, reflow of elements of the webpage 120 is supported while enabling the annotations to remain associated with corresponding relative locations of the webpage 120 that are relevant as previously described in relation to FIG. 3. A variety of other examples are also contemplated.

Example System and Device

FIG. 22 illustrates an example system generally at 2200 that includes an example computing device 2202 that is representative of one or more computing systems and/or devices that may implement the various techniques described herein as shown through inclusion of the browser 114 and annotation module 116. The computing device 2202 may be, for example, a server of a service provider, a device associated with a client (e.g., a client device), an on-chip system, and/or any other suitable computing device or computing system.

The example computing device 2202 as illustrated includes a processing system 2204, one or more computer-readable media 2206, and one or more I/O interface 2208 that are communicatively coupled, one to another. Although not shown, the computing device 2202 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 2204 is representative of functionality to perform one or more operations using hardware. Accordingly, the processing system 2204 is illustrated as including hardware element 2210 that may be configured as processors, functional blocks, and so forth. This may include implementation in hardware as an application specific integrated circuit or other logic device formed using one or more semiconductors. The hardware elements 2210 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 2206 is illustrated as including memory/storage 2212. The memory/storage 2212 represents memory/storage capacity associated with one or more computer-readable media. The memory/storage component 2212 may include volatile media (such as random access memory (RAM)) and/or nonvolatile media (such as read only memory (ROM), Flash memory, optical disks, magnetic disks, and so forth). The memory/storage component 2212 may include fixed media (e.g., RAM, ROM, a fixed hard drive, and so on) as well as removable media (e.g., Flash memory, a removable hard drive, an optical disc, and so forth). The computer-readable media 2206 may be configured in a variety of other ways as further described below.

Input/output interface(s) 2208 are representative of functionality to allow a user to enter commands and information to computing device 2202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 2202 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 2202. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 2202, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 2210 and computer-readable media 2206 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 2210. The computing device 2202 may be configured to implement particular instructions and/or functions corresponding to the software and/or hardware modules. Accordingly, implementation of a module that is executable by the computing device 2202 as software may be achieved at least partially in hardware, e.g., through use of computer-readable storage media and/or hardware elements 2210 of the processing system 2204. The instructions and/or functions may be executable/operable by one or more articles of manufacture (for example, one or more computing devices 2202 and/or processing systems 2204) to implement techniques, modules, and examples described herein.

As further illustrated in FIG. 22, the example system 2200 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 2200, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 2202 may assume a variety of different configurations, such as for computer 2214, mobile 2216, and television 2218 uses. Each of these configurations includes devices that may have generally different constructs and capabilities, and thus the computing device 2202 may be configured according to one or more of the different device classes. For instance, the computing device 2202 may be implemented as the computer 2214 class of a device that includes a personal computer, desktop computer, a multi-screen computer, laptop computer, netbook, and so on.

The computing device 2202 may also be implemented as the mobile 2216 class of device that includes mobile devices, such as a mobile phone, portable music player, portable gaming device, a tablet computer, a multi-screen computer, and so on. The computing device 2202 may also be implemented as the television 2218 class of device that includes devices having or connected to generally larger screens in casual viewing environments. These devices include televisions, set-top boxes, gaming consoles, and so on.

The techniques described herein may be supported by these various configurations of the computing device 2202 and are not limited to the specific examples of the techniques described herein. This functionality may also be implemented all or in part through use of a distributed system, such as over a “cloud” 2220 via a platform 2222 as described below.

The cloud 2220 includes and/or is representative of a platform 2222 for resources 2224. The platform 2222 abstracts underlying functionality of hardware (e.g., servers) and software resources of the cloud 2220. The resources 2224 may include applications and/or data that can be utilized while computer processing is executed on servers that are remote from the computing device 2202. Resources 2224 can also include services provided over the Internet and/or through a subscriber network, such as a cellular or Wi-Fi network.

The platform 2222 may abstract resources and functions to connect the computing device 2202 with other computing devices. The platform 2222 may also serve to abstract scaling of resources to provide a corresponding level of scale to encountered demand for the resources 2224 that are implemented via the platform 2222. Accordingly, in an interconnected device embodiment, implementation of functionality described herein may be distributed throughout the system 2200. For example, the functionality may be implemented in part on the computing device 2202 as well as via the platform 2222 that abstracts the functionality of the cloud 2220.

### Conclusion and Example Implementations

Example implementations described herein include, but are not limited to, one or any combinations of one or more of the following examples:

In one or more examples, a method is described to control and manage access to annotations made via a browser to transform a webpage. The method includes displaying the webpage by the browser executed by a computing device; receiving one or more inputs by the computing device via the browser as one or more annotations to the webpage; capturing an image of the displayed webpage and the one or more annotations that are made in relation to the display of the webpage by the browser of the computing device; and controlling access via the browser to the annotated webpage through use of the one or more annotations and the captured image of the webpage.

In one or more examples, a method is described to control and manage display of annotations made via a browser to transform a webpage. The method includes displaying the webpage by the browser executed by a computing device; receiving one or more inputs by the computing device via the browser as one or more annotations to the webpage; capturing an image of the displayed webpage, the one or more annotations, and hypertext markup language (HTML) associated with the webpage; anchoring the one or more annotations with respective elements of the webpage through use of the captured hypertext markup language (HTML); and controlling display of the annotated webpage to support a plurality of different layouts using the captured hypertext markup language such that the one or more annotations are anchored with the respective elements.

An example as described alone or in combination with any of the above or below examples, in which the controlling access includes responsive to receipt of one or more inputs to access the annotated webpage, retrieving and displaying the annotated webpage using the one or more annotations and the captured image via the browser.

An example as described alone or in combination with any of the above or below examples, in which the one or more inputs to access the annotated webpage are implemented through interaction with a list of favorites, a reading list, or a notes section of the browser.

An example as described alone or in combination with any of the above or below examples, in which the captured image and the one or more annotations are stored in a computer readable medium that is local to the computing device or is remotely accessible from a service provider via a network.

An example as described alone or in combination with any of the above or below examples, in which capturing hypertext markup language (HTML) associated with the webpage and the controlling of the access includes the captured hypertext markup language.

An example as described alone or in combination with any of the above or below examples, in which the captured hypertext markup language is configured to support a plurality of different layouts of the annotated webpage such that a first said layout includes an arrangement of elements includes in the annotated webpage that is different than an arrangement of the elements in a second said layout.

An example as described alone or in combination with any of the above or below examples, in which the captured hypertext markup language is configured to support use of one or more hyperlinks included in the webpage.

An example as described alone or in combination with any of the above or below examples, in which the controlling includes an option to cause or not cause display of the one or more annotations in relation to the captured image.

An example as described alone or in combination with any of the above or below examples, in which responsive to receipt of one or more inputs to cause sharing of the annotated webpage with a user, transmitting a link by the computing device to a network location maintained by a service provider via which the annotated webpage is accessible via a computing device of the user.

An example as described alone or in combination with any of the above or below examples, including capturing a uniform resource locator (URL) associated with the webpage by the computing device; identifying a website and a user account associated with the webpage from the captured URL; and providing an option to post the annotated webpage back to the identified user account of the website based on the identifying.

An example as described alone or in combination with any of the above or below examples, including the website is part of a social network and the user account is a user profile.

An example as described alone or in combination with any of the above or below examples, including responsive to identification of a subsequent request to navigate to the webpage via the browser by the computing device, providing an option to cause the display of the annotated webpage.

An example as described alone or in combination with any of the above or below examples, in which the plurality of different layouts of the annotated webpage include a first said layout having an arrangement of elements includes in the annotated webpage that is different than an arrangement of the elements in a second said layout.

An example as described alone or in combination with any of the above or below examples, in which the captured hypertext markup language is configured to support use of one or more hyperlinks included in the webpage.

An example as described alone or in combination with any of the above or below examples, in which the controlling includes an option to cause or not cause display of the one or more annotations in relation to the captured image.

An example as described alone or in combination with any of the above or below examples, including responsive to receipt of one or more inputs to cause sharing of the annotated webpage with a user, transmitting a link by the computing device to a network location maintained by a service provider via which the annotated webpage is accessible via a computing device of the user.

In one or more examples, a system is described to control and manage access to annotations made via a browser to transform a webpage. The system includes at least one computing device having one or more modules implemented at least partially in hardware. The one or more modules are configured to perform operations comprising: displaying the webpage by the browser executed by a computing device; receiving one or more inputs by the computing device via the browser as one or more annotations to the webpage; capturing an image of the displayed webpage and the one or more annotations that are made in relation to the display of the webpage by the browser of the computing device; identifying a website and a user account associated with the webpage from a uniform resource locator (URL) of the webpage; and providing an option to post the annotated webpage back to the identified user account of the website based on the identifying.

An example as described alone or in combination with any of the above or below examples, in which the plurality of different layouts of the annotated webpage include a first said layout having an arrangement of elements includes in the annotated webpage that is different than an arrangement of the elements in a second said layout.

An example as described alone or in combination with any of the above or below examples, in which the captured hypertext markup language is configured to support use of one or more hyperlinks included in the webpage.

An example as described alone or in combination with any of the above or below examples, in which the controlling includes an option to cause or not cause display of the one or more annotations in relation to the captured image.

An example as described alone or in combination with any of the above or below examples, including responsive to receipt of one or more inputs to cause sharing of the annotated webpage with a user, transmitting a link by the computing device to a network location maintained by a service provider via which the annotated webpage is accessible via a computing device of the user.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A method to control and manage access to annotations made via a browser to transform a webpage, the method comprising:
displaying the webpage by the browser executed by a computing device;
receiving one or more inputs by the computing device via the browser as one or more annotations to the webpage;
capturing an image of the displayed webpage and the one or more annotations that are made in relation to the display of the webpage by the browser of the computing device; and
controlling access via the browser to the annotated webpage through use of the one or more annotations and the captured image of the webpage.

2. A method as described in claim 1, wherein the controlling access includes responsive to receipt of one or more inputs to access the annotated webpage, retrieving and displaying the annotated webpage using the one or more annotations and the captured image via the browser.

3. A method as described in claim 2, wherein the one or more inputs to access the annotated webpage are implemented through interaction with a list of bookmarks, a reading list, or a notes section of the browser.

4. A method as described in claim 1 wherein the captured image and the one or more annotations are stored in a computer readable medium that is local to the computing device or is remotely accessible from a service provider via a network.

5. A method as described in claim 1, further comprising capturing hypertext markup language (HTML) associated with the webpage and the controlling of the access includes the captured hypertext markup language.

6. A method as described in claim 5, wherein the captured hypertext markup language is configured to support a plurality of different layouts of the annotated webpage such that a first said layout includes an arrangement of elements includes in the annotated webpage that is different than an arrangement of the elements in a second said layout.

7. A method as described in claim 5, wherein the captured hypertext markup language is configured to support use of one or more hyperlinks included in the webpage.

8. A method as described in claim 1, wherein the controlling includes an option to cause or not cause display of the one or more annotations in relation to the captured image.

9. A method as described in claim 1, further comprising responsive to receipt of one or more inputs to cause sharing of the annotated webpage with a user, transmitting a link by the computing device to a network location maintained by a service provider via which the annotated webpage is accessible via a computing device of the user.

10. A method as described in claim 1, further comprising:
capturing a uniform resource locator (URL) associated with the webpage by the computing device;
identifying a website and a user account associated with the webpage from the captured URL; and
providing an option to post the annotated webpage back to the identified user account of the website based on the identifying.

11. A method as described in claim 10, wherein the website is part of a social network and the user account is a user profile.

12. A method as described in claim 1, further comprising responsive to identification of a subsequent request to navigate to the webpage via the browser by the computing device, providing an option to cause the display of the annotated webpage.

13. A method to control and manage display of annotations made via a browser to transform a webpage, the method comprising:
displaying the webpage by the browser executed by a computing device;
receiving one or more inputs by the computing device via the browser as one or more annotations to the webpage;
capturing an image of the displayed webpage, the one or more annotations, and hypertext markup language (HTML) associated with the webpage;
anchoring the one or more annotations with respective elements of the webpage through use of the captured hypertext markup language (HTML); and
controlling display of the annotated webpage to support a plurality of different layouts using the captured hypertext markup language such that the one or more annotations are anchored with the respective elements.

14. A method as described in claim 13, wherein the plurality of different layouts of the annotated webpage include a first said layout having an arrangement of elements includes in the annotated webpage that is different than an arrangement of the elements in a second said layout.

15. A method as described in claim 13, wherein the captured hypertext markup language is configured to support use of one or more hyperlinks included in the webpage.

16. A method as described in claim 13, wherein the controlling includes an option to cause or not cause display of the one or more annotations in relation to the captured image.

17. A method as described in claim 13, further comprising responsive to receipt of one or more inputs to cause sharing of the annotated webpage with a user, transmitting a link by the computing device to a network location maintained by a service provider via which the annotated webpage is accessible via a computing device of the user.

18. A method as described in claim 13, further comprising:
capturing a uniform resource locator (URL) associated with the webpage by the computing device;
identifying a website and a user profile associated with the webpage from the captured URL; and
providing an option to post the annotated webpage back to the identified user profile of the website based on the identifying.

19. A system to control and manage access to annotations made via a browser to transform a webpage, the system comprising:
at least one computing device having one or more modules implemented at least partially in hardware, the one or more modules configured to perform operations comprising:
displaying the webpage by the browser executed by a computing device;
receiving one or more inputs by the computing device via the browser as one or more annotations to the webpage;
capturing an image of the displayed webpage and the one or more annotations that are made in relation to the display of the webpage by the browser of the computing device;
identifying a website and a user account associated with the webpage from a uniform resource locator (URL) of the webpage; and
providing an option to post the annotated webpage back to the identified user account of the website based on the identifying.

20. A system as described in claim 19, wherein the website is part of a social network and the user account is a user profile.
